(19) United States
(12) Patent Application Publication
(10) Pub. No.: US 2026/0336593 A1
(43) Pub. Date: Oct. 29, 2026

(54) Actuator Assembly

(71) Applicant: ZF Active Safety GmbH, Koblenz (DE)

(72) Inventors: Nikolas Thoennissen, Koblenz (DE); Markus Reinhard, Lahnstein (DE); Estefania del Cazo Palos, Koblenz (DE)

(21) Appl. No.: 19/661,762

(22) Filed: Apr. 29, 2026

(30) Foreign Application Priority Data
Apr. 29, 2025 (DE) 102025116542.4

(51) Int. Cl. B60T 17/22; B60T 13/74; F16D 55/00; F16D 55/226; F16D 65/18; F16D 66/00; F16D 121/24; F16D 125/40; H02K 7/116; H02K 11/215

(52) U.S. Cl. CPC B60T 17/22; B60T 13/746; F16D 55/226; F16D 65/18; F16D 66/00; H02K 7/116; H02K 11/215; F16D 2055/0016; F16D 2066/003; F16D 2121/24; F16D 2125/40; H02K 2211/03

(57) ABSTRACT

The invention specifies an actuator assembly (10) for a vehicle brake, having a brake calliper in which an intermediate space for a brake rotor is formed, an actuating piston for a brake lining, wherein the actuating piston can be moved selectively between a retracted position and an extended position, and an electric motor (26) which is coupled for drive purposes to the actuating piston via a gear unit and a spindle drive in order to move the actuating piston between the retracted position and the extended position. The actuator assembly also comprises a magnet holder (44) which is screwed directly or indirectly via an intermediate element (54) to an output shaft (34) of the electric motor (26) by means of a screw connection (46) and receives a magnet (42) as part of a motor position sensor (36). The screw connection (46) has at least one thread pairing (48) and the external thread (50) and the internal thread (52) of the thread pairing (48) have a different thread pitch, or the screw connection (46) comprises at least two thread pairings which have different thread pitches, wherein the external thread and the internal thread of a thread pairing both have the same thread pitch.

### TECHNICAL FIELD

The invention relates to an actuator assembly for a vehicle brake.

### BACKGROUND

Actuator assemblies of this kind usually comprise a brake calliper in which an intermediate space for a brake rotor is formed, an actuating piston which can be moved selectively between a retracted position and an extended position, and an electric motor which is coupled for drive purposes to the actuating piston via a gear unit and a spindle drive in order to move the actuating piston between the retracted position and the extended position.

In order to detect a current state of the vehicle brake, a motor position sensor, which is generally a Hall sensor, is usually provided.

One challenge when using Hall sensors is that the axial distance of a magnet relative to the Hall element has to be set with high precision and this position has to be maintained over the entire service life of the actuator assembly in order to ensure that the motor position is detected with sufficient accuracy. Since rotation of the electric motor causes a relatively high rotational acceleration of the magnet or a corresponding magnet holder, there is a risk of the axial position of the magnet holder changing over the service life. In order to prevent this, securing elements are usually used for fixing the magnet holder, but this has a disadvantageous effect on the total cost of the actuator assembly.

### SUMMARY

It is therefore an object of the invention to provide an actuator assembly for a vehicle brake, which actuator assembly is optimized with regard to the fastening of a magnet holder for the magnet of a motor position sensor.

According to the invention, this object is achieved by an actuator assembly for a vehicle brake, having a brake calliper in which an intermediate space for a brake rotor is formed, an actuating piston for a brake lining, wherein the actuating piston can be moved selectively between a retracted position and an extended position, and an electric motor which is coupled for drive purposes to the actuating piston via a gear unit and a spindle drive in order to move the actuating piston between the retracted position and the extended position. The actuator assembly further comprises a magnet holder which is screwed directly or indirectly via an intermediate element to an output shaft of the electric motor by means of a screw connection and receives a magnet as part of a motor position sensor. In one variant, the screw connection has at least one thread pairing, for example exactly one thread pairing, and the external thread and the internal thread of the thread pairing have a different thread pitch. In a further variant, the screw connection comprises at least two thread pairings which have different thread pitches, wherein the external thread and the internal thread of a thread pairing both have the same thread pitch.

In both variants, the difference in pitch is selected such that the magnet holder can still be screw-connected, with internal thread stress occurring. In other words, the magnet holder is caulked with the output shaft or the intermediate element owing to the difference in pitch.

Due to the caulking, the magnet holder sits fixedly on the output shaft and cannot be automatically released even in the event of rotation of the output shaft. Due to the increased friction prevailing at the thread flanks, a moment that counteracts the rotational moment of inertia in the event of rotational acceleration of the magnet holder is generated in particular. The axial position of the magnet holder is therefore maintained with sufficient precision over the entire service life of the actuator assembly.

According to the invention, no additional mechanical securing elements or adhesives are required in order to axially fix the magnet holder.

A further advantage of the invention is that the axial position of the magnet holder can be set particularly precisely by means of the screw connection. This allows optimum setting of the sensitivity and accuracy of the motor position sensor.

The difference between the different thread pitches is 0.1 to 0.5, for example. In a specific example, the difference between the different thread pitches is 0.3.

Such a difference provides sufficient protection against the screw connection being automatically released. At the same time, the screw connection can be established without excessive application of force.

According to one embodiment, the screw connection comprises two thread pairings, wherein the thread pairings are arranged either in an axially overlapping manner and concentrically in relation to each other, in other words parallel in relation to each other, or at an axial distance in relation to each other and concentrically in relation to each other in an axial view, in other words in series in relation to each other. In the case of thread pairings arranged in series, one thread of each thread pairing can be formed in a stepped bore.

The use of two thread pairings increases the structural integrity of the connection. In other words, the load distribution takes place over two contact surfaces, which increases the load-bearing ability of the connection. In addition, two thread pairings can improve the alignment of the magnet holder with the output shaft by way of preventing one of the thread pairings from tilting.

According to one variant, the magnet holder has a circumferential groove which is coaxial with the centre axis of the output shaft and has a radially inwardly facing wall having a first thread and a radially outwardly facing wall having second thread, wherein a cylindrical ring with an internal thread and an external thread is screwed into the respective thread in the magnet holder in order to form the two thread pairings. In this embodiment, one thread of each thread pairing is thus formed in the groove. This allows for a compact design that minimizes the required installation space, in particular in the axial direction.

The cylindrical ring is formed, in particular, in the intermediate element or in the output shaft.

According to a further variant, the magnet holder has two axially successive internal or external threads into which two axially successive external or internal threads of the intermediate element or the output shaft are screwed in order to form the two thread pairings. In comparison to the abovementioned variant, the space requirement in the radial direction is optimized here. In other words, this variant is advantageous if there is more space in the axial direction than in the radial direction.

The two axially successive internal or external threads can be provided on portions of different diameter of the magnet holder and, additionally, of the intermediate element or of the output shaft. Here, an internal or external thread of the magnet holder together with a corresponding internal or external thread of the intermediate element or of the output shaft forms a thread pairing in each case. By way of providing the axially successive internal or external threads on portions of different diameter of the magnet holder, the external thread of smaller diameter can first be passed through the internal thread of larger diameter, before being screwed into the corresponding external thread. Both threads provided on the magnet holder can be screw-connected at the same time here.

The intermediate element can be a pinion which is pressed onto the output shaft of the electric motor, wherein the magnet holder is screwed to the pinion by means of the screw connection. The fact that the already existing pinion is used as the intermediate element also contributes to a compact design and a reduced number of components.

Pressing the pinion onto the output shaft ensures a fixed and permanent connection that can transfer high torques without slipping. This means that unalterable positioning of the magnet holder relative to the output shaft can be implemented by means of the pinion.

The pinion can comprise a collar which extends starting from a toothed ring of the pinion, wherein the at least one thread pairing is formed between the collar and the magnet holder. For example, either an internal thread or an external thread, or both, is/are formed on the collar. The collar forms an extension of the pinion, so that the at least one thread pairing can be formed with a sufficient thread length. In particular, the collar forms the cylindrical ring which is screwed into the circumferential groove in the magnet holder.

The pinion, more precisely the collar, projects, for example, axially beyond the output shaft of the electric motor. This creates sufficient clearance for a thread on the inside of the collar.

According to one embodiment, the magnet holder is screwed directly on the output shaft of the electric motor, wherein the magnet holder is arranged on a side of the electric motor facing away from the gear unit. In this case, no intermediate element is required, which contributes to a compact design. In this case, there is preferably exactly one thread pairing, wherein the external thread and the internal thread of the thread pairing have a different thread pitch, and wherein the external thread is formed on the output shaft of the electric motor.

The magnet holder has, for example, a receptacle in which the magnet is pressed or adhesively bonded. This ensures that the magnet is securely and permanently fixed to the magnet holder, which prevents the magnet from slipping or becoming detached, even under vibration or mechanical loads.

There can be a protuberance on an inner wall of the receptacle, in particular a circumferential protuberance by way of which the magnet is held along its circumferential wall in the receptacle in a force-fitting manner. In addition to the holding function, the protuberance also serves to centre the magnet in the receptacle.

The protuberance is arranged, for example, adjacent to an end-side opening in the receptacle.

According to one aspect, the actuator assembly comprises a printed circuit board on which a Hall element is arranged, the Hall element, as viewed in the longitudinal direction of the output shaft, overlapping with the magnet and forming a motor position sensor together with the magnet. For example, no further elements are arranged between the magnet and the Hall element. This ensures sufficient sensitivity of the motor position sensor.

According to the invention, the axial distance of the magnet in relation to the Hall element can be precisely set via the screw connection.

### BRIEF DESCRIPTION OF THE DRAWINGS

Further advantages and features of the invention will become apparent from the following description and from the accompanying drawings, to which reference is made. In the drawings:

FIG. 1 shows an actuator assembly according to the invention,

FIG. 2 schematically shows a motor assembly of the actuator assembly according to the invention,

FIG. 3 shows a cross section through a screw connection for fastening a magnet holder of a motor position sensor,

FIG. 4 schematically shows an alternative motor assembly for an actuator assembly according to the invention,

FIG. 5 schematically shows another alternative motor assembly for an actuator assembly according to the invention,

FIG. 6 shows a further screw connection for fastening a magnet holder of a motor position sensor,

FIG. 7 shows the screw connection from FIG. 6 in a screw-connected state,

FIG. 8 shows a further alternative motor assembly for an actuator assembly according to the invention, and

FIG. 9 shows another alternative motor assembly for an actuator assembly according to the invention.

### DESCRIPTION

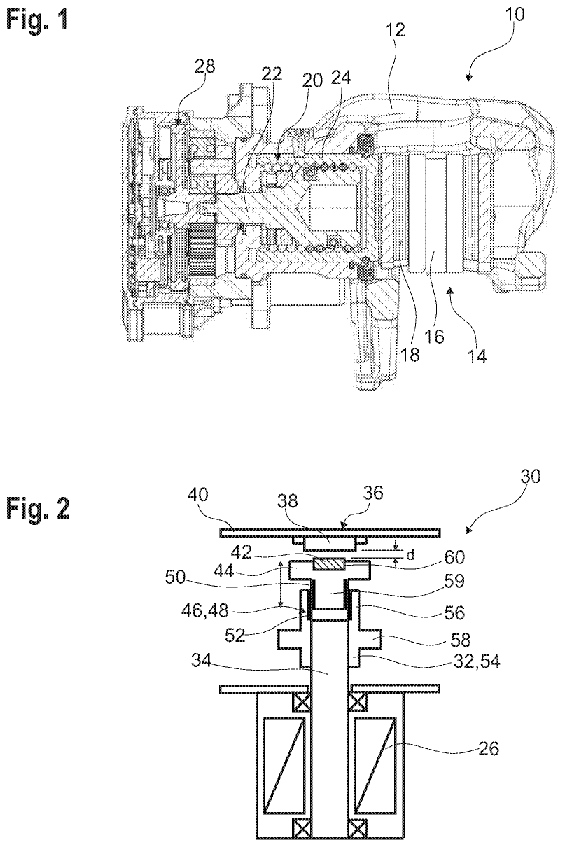

FIG. 1 shows an actuator assembly 10 for a vehicle brake, more precisely for an electromechanically actuable brake.

The actuator assembly 10 comprises a brake calliper 12 in which an intermediate space 14 for a brake rotor 16 is formed.

A brake pad 18 which can be applied to the brake rotor 16 is arranged in the intermediate space 14.

The actuator assembly 10 furthermore comprises a spindle drive 20, which in the exemplary embodiment is a ball screw mechanism, having a rotatably mounted spindle 22 which is driven by an electric motor and on which is mounted an actuating piston 24. The actuating piston 24 represents a spindle nut. The spindle 22 serves for axially moving the actuating piston 24.

Specifically, the actuating piston 24 can be moved by axial displacement between an extended and a retracted position.

In order to drive the spindle 22, an electric motor 26 is provided, which is not shown in FIG. 1.

The electric motor 26 (see FIG. 2) is coupled for drive purposes to the actuating piston 24 via a gear unit 28 and the spindle drive 20 in order to move the actuating piston between the retracted position and the extended position.

A longitudinal axis of the electric motor 26 runs parallel to the longitudinal axis of the spindle drive 20.

FIG. 2 schematically shows a motor assembly 30 which comprises the electric motor 26.

In addition, FIG. 2 shows a pinion 32 which is arranged on an output shaft 34 of the electric motor and is the constituent part of the gear unit 28. The gear unit 28 comprises, for example, a spur gear.

The pinion 32 is pressed on the output shaft 34 and therefore cannot move on the output shaft 34.

In addition to the electric motor 26, the motor assembly 30 comprises a motor position sensor 36 which is configured to detect a motor position.

The motor position sensor 36 has a Hall element 38 which is arranged on a printed circuit board 40, in particular is soldered on the printed circuit board, and a magnet 42 which is received in a magnet holder 44.

The Hall element 38 overlaps with the magnet 42 as viewed in the longitudinal direction of the output shaft 34.

The magnet 42 is arranged at an axial distance d relative to the Hall element 38.

This distance d has to be set very precisely and must not change due to the rotational moment of inertia occurring in the event of rotational acceleration even during operation of the actuator assembly 10. In other words, it is necessary to ensure that the axial position of the magnet holder 44 relative to the output shaft 34 remains the same.

This is achieved in that the magnet holder 44 is screwed to the output shaft 34 of the electric motor 26 by means of a screw connection 46, wherein the screw connection 46 is secured against becoming loose.

For this purpose, the screw connection 46 comprises at least two threads which have a different thread pitch, so that internal thread tension or caulking occurs when the screw connection 46 is screw-connected, which prevents the magnet holder 44 from being automatically released.

In the embodiment shown in FIG. 2, this is implemented in that the screw connection 46 has exactly one thread pairing 48 and the external thread 50 and the internal thread 52 of the thread pairing 48 have a different thread pitch.

The threads are illustrated in the figures by bold lines.

The difference between the thread pitches is, for example, between 0.1 and 0.5, in particular 0.3.

In the exemplary embodiment according to FIG. 2, the magnet holder 44 is screwed to the output shaft 34 of the electric motor 26 indirectly via the pinion 32, so that the pinion 32 constitutes an intermediate element 54 in the connection of the magnet holder 44 to the output shaft 34. However, the intermediate element 54 does not necessarily have to be formed by the pinion 32; other intermediate elements are also conceivable.

In the exemplary embodiment according to FIG. 2, the magnet holder 44 has the external thread 50 and the pinion 32 has the internal thread 52.

In order to provide space for the internal thread 52, the pinion 32 has a collar 56 which extends starting from a toothed ring 58 of the pinion 32 and which projects axially beyond the output shaft 34 of the electric motor 26. The internal thread 52 is formed on an inside of the collar 56.

The thread pairing 48 is thus formed between the collar 56 and the magnet holder 44.

For this purpose, the magnet holder 44 has a pin 59 on which the external thread 50 is formed.

The magnet holder 44 has a receptacle 60 in which the magnet 42 is pressed or adhesively bonded. The receptacle 60 is described in more detail below.

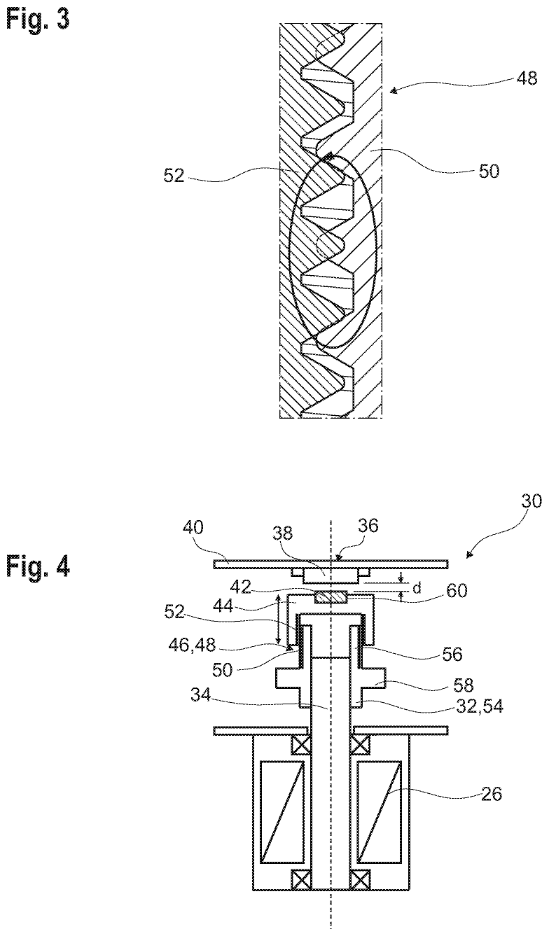

FIG. 3 shows a cross section through the screw connection described in connection with FIG. 2. In FIG. 3, the different thread pitch can be recognized by the fact that the threads partially collide with each other, which in reality leads to the abovementioned caulking.

FIG. 4 schematically shows a further embodiment of the motor assembly 30 which can likewise be used in the actuator assembly 10.

In the description below, the same reference signs are used for identical structures with the same functions as known from the above embodiment, and to this extent reference is made to the preceding explanations, wherein only the differences between the respective embodiments will be discussed below so as to avoid repetition.

The motor assembly 30 shown in FIG. 4 differs from the motor assembly 30 described in connection with FIG. 2 in that the internal thread 52 of the screw connection 46 is provided on the magnet holder and the external thread 50 on the intermediate element 54 and on the pinion 32 respectively. In other words, the arrangement of the internal thread 52 and the external thread 50 is reversed compared to FIG. 2.

In order to be able to form the internal thread 52 on the magnet holder 44, the magnet holder is formed in a pot shape and surrounds the pinion 32, more precisely the collar 56, in sections.

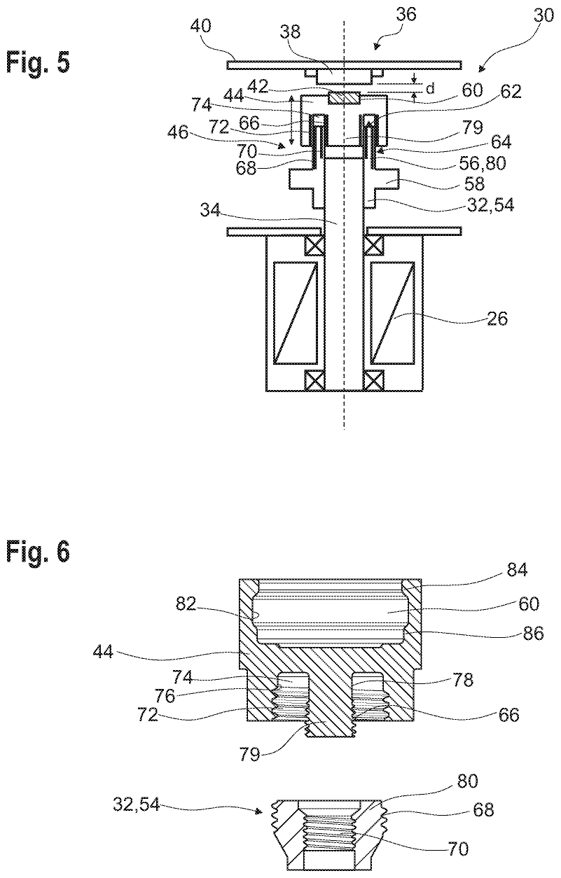

FIG. 5 schematically shows a further embodiment of a motor assembly 30 for the actuator assembly 10 which likewise differs in the form of the screw connection 46 from the above-described embodiments.

In the exemplary embodiment illustrated in FIG. 5, the screw connection 46 has two thread pairings 62, 64 which have different thread pitches, wherein the external thread 66, 68 and the internal thread 70, 72 of a thread pairing 62, 64 both have the same thread pitch.

The difference between the thread pitches is also between 0.1 and 0.5, in particular 0.3, in this exemplary embodiment.

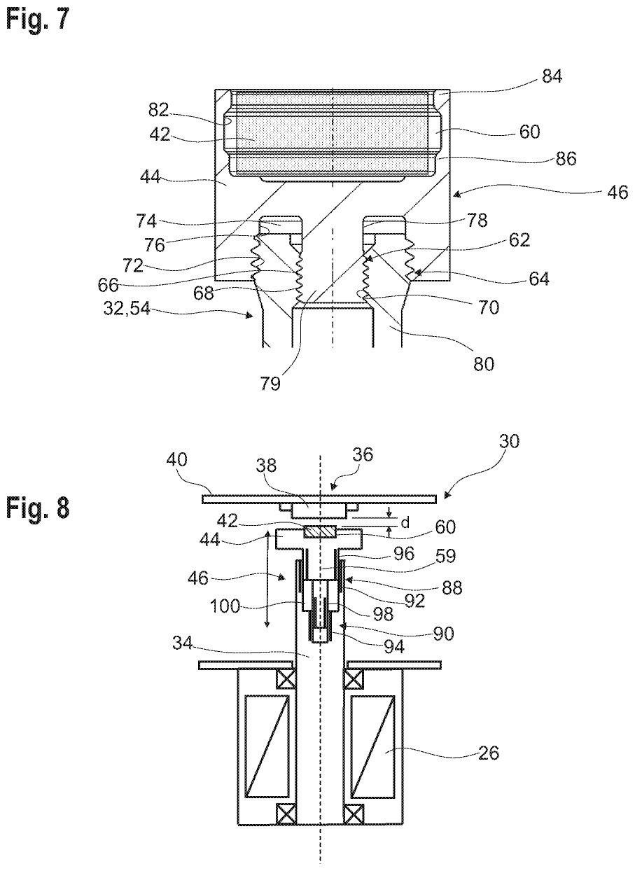

The screw connection 46 from FIG. 5 is illustrated in more detail in FIGS. 6 and 7.

The two thread pairings 62, 64 are arranged in an axially overlapping manner and concentrically in relation to each other, in other words parallel to each other (see FIG. 7).

In this exemplary embodiment, the magnet holder 44 has a circumferential groove 74 which is coaxial with the centre axis of the output shaft 34. The groove 74 extends in particular from an end side of the magnet holder 44 parallel to the longitudinal axis of the magnet holder 44. Specifically, the groove 74 is annular.

The groove 74 has a radially inwardly facing wall 76 having a first thread, more precisely the internal thread 72 of the thread pairing 64, and a radially outwardly facing wall 78 having a second thread, more precisely the external thread 66 of the thread pairing 62.

A pin 79 on which the radially outwardly facing wall 78 is present is formed radially within the groove 74.

The pin 79 extends beyond the groove 74, but alternatively the pin 79 can end at the same height as the groove 74.

A cylindrical ring 80, on which the internal thread 70 of the thread pairing 62 and the external thread 68 of the thread pairing 64 are formed, is provided in a complementary manner to the groove 74.

The ring 80 is screwed into the respective threads 66, 72 in the magnet holder 44 in order to form the two thread pairings 62, 64.

In the exemplary embodiment, the ring 80 is formed by the collar 56 of the pinion 32, but it is also conceivable for there to be a separate ring 80 which is pressed, for example, onto the output shaft 34.

The shape of the receptacle 60 in which the magnet 42 is received is described in more detail below in connection with FIGS. 6 and 7.

The magnet 42 is cylindrical in the exemplary embodiment. The receptacle 60 accordingly has a cylindrical basic shape.

There is a protuberance 84, which is circumferential in the exemplary embodiment, on an inner wall 82 of the receptacle 60.

The protuberance 84 is arranged adjacent to an end-side opening in the receptacle 60.

In addition, there can be a further circumferential protuberance 86 on the bottom of the receptacle 60.

The magnet is held along its circumferential wall in the receptacle 60 in a force-fitting manner by the protuberances 84, 86.

FIG. 8 schematically illustrates a further embodiment of a motor assembly 30 for the actuator assembly 10.

The motor assembly 30 according to FIG. 8 differs from the above-described embodiments by the arrangement of the thread pairings.

Specifically, the embodiment illustrated in FIG. 8 has two thread pairings 88, 90 which both comprise an internal thread 92, 94 and an external thread 96, 98.

The thread pairings 88, 90 are arranged at an axial distance in relation to each other and concentrically in relation to each other in an axial view.

In other words, the magnet holder 44 has two axially successive external threads 96, 98 which are screwed into two axially successive internal threads 92, 94 of the output shaft 34 in order to form the two thread pairings 88, 90.

There are two axially successive external threads 96, 98 on portions of different diameter of the magnet holder 44.

The internal threads 92, 94 are formed on portions of different inside diameter of a stepped bore 100 present in the output shaft 34.

In the exemplary embodiment shown in FIG. 8, the magnet holder 44 is screwed directly in the output shaft 34 by means of the screw connection 46. As an alternative however, an intermediate element can be provided, as already described above.

In a further alternative embodiment, which is not illustrated for the sake of simplicity, the stepped bore 100 can be formed in the magnet holder 44, so that the internal threads 92, 94 are formed on the magnet holder 44 and the external threads 96, 98 are formed on the output shaft 34 or a corresponding intermediate element.

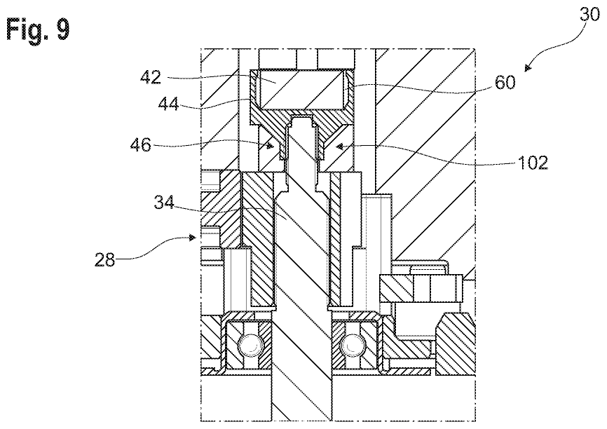

FIG. 9 shows a further embodiment of the motor assembly 30, in which the screw connection 46 comprises a single thread pairing 102 which is formed between the output shaft 34 and the magnet holder 44, that is without an intermediate element.

In the illustrated exemplary embodiment, the magnet holder 44 is arranged on a side of the electric motor 26 facing the gear unit 28.

In a further embodiment, which is not illustrated for the sake of simplicity, the magnet holder 44 can be arranged on a side of the electric motor 26 facing away from the gear unit 28.

1. Actuator assembly (10) for a vehicle brake, having
a brake calliper (12) in which an intermediate space (14) for a brake rotor (16) is formed,
an actuating piston (24) for a brake lining, wherein the actuating piston (24) can be moved selectively between a retracted position and an extended position, and
an electric motor (26) which is coupled for drive purposes to the actuating piston (24) via a gear unit (28) and a spindle drive (20) in order to move the actuating piston (24) between the retracted position and the extended position,
and having a magnet holder (44) which is screwed directly or indirectly via an intermediate element (54) to an output shaft (34) of the electric motor (26) by means of a screw connection (46) and receives a magnet (42) as part of a motor position sensor (36),
wherein the screw connection (46) has at least one thread pairing (48, 102) and the external thread (50) and the internal thread (52) of the thread pairing (48) have a different thread pitch, or
wherein the screw connection (46) comprises at least two thread pairings (62, 64, 88, 90) which have different thread pitches, wherein the external thread (66, 68, 96, 98) and the internal thread (70, 72, 92, 94) of a thread pairing (62, 64, 88, 90) both have the same thread pitch.

2. Actuator assembly (10) according to claim 1, wherein the difference between the different thread pitches is 0.1 to 0.5.

3. Actuator assembly (10) according to claim 1, wherein the screw connection (46) comprises two thread pairings (62, 64) and the two thread pairings (62, 64) are arranged in an axially overlapping manner and concentrically in relation to each other or at an axial distance in relation to each other and concentrically in relation to each other in an axial view.

4. Actuator assembly (10) according to claim 1, wherein the magnet holder (44) has a circumferential groove (74) which is coaxial with the centre axis of the output shaft (34) and has a radially inwardly facing wall (76) having a first thread (72) and a radially outwardly facing wall (78) having second thread (66), wherein a cylindrical ring (80) with an internal thread (70) and an external thread (68) is screwed into the respective thread (66, 72) in the magnet holder (44) in order to form the two thread pairings (62, 64).

5. Actuator assembly (10) according to claim 1, wherein the magnet holder (44) has two axially successive internal or external threads (96, 98) into which two axially successive external or internal threads (92, 94) of the intermediate element (54) or of the output shaft (34) are screwed in order to form the two thread pairings (88, 90).

6. Actuator assembly (10) according to claim 5, wherein the two axially successive internal or external threads (92, 94, 96, 98) are provided on portions of different diameter of the magnet holder (44) and, additionally, of the intermediate element (54) or the output shaft (34).

7. Actuator assembly (10) according to claim 1, wherein the intermediate element (54) is a pinion (32) which is pressed onto the output shaft (34) of the electric motor (26), wherein the magnet holder (44) is screwed to the pinion (32) by means of the screw connection (46).

8. Actuator assembly (10) according to claim 7, wherein the pinion (32) comprises a collar (56) which extends starting from a toothed ring (58) of the pinion (32), wherein the at least one thread pairing (48) is formed between the collar (56) and the magnet holder (44).

9. Actuator assembly (10) according to claim 7, wherein the pinion (32), in particular the collar (56), projects axially beyond the output shaft (34) of the electric motor (26).

10. Actuator assembly (10) according to claim 1, wherein the magnet holder (44) is screwed directly on the output shaft (34) of the electric motor (26), wherein the magnet holder (44) is arranged on a side of the electric motor (26) facing away from the gear unit (28).

11. Actuator assembly (10) according to claim 1, wherein the magnet holder (44) has a receptacle (60) in which the magnet (42) is pressed or adhesively bonded.

12. Actuator assembly (10) according to claim 11, wherein there is a protuberance (84) on an inner wall (82) of the receptacle (60), in particular a circumferential protuberance (84) by way of which the magnet (42) is held along its circumferential wall in the receptacle (60) in a force-fitting manner.

13. Actuator assembly (10) according to claim 11, wherein the actuator assembly (10) comprises a printed circuit board (40) on which a Hall element (38) is arranged, the Hall element, as viewed in the longitudinal direction of the output shaft (34), overlapping with the magnet (42) and forming a motor position sensor (36) together with the magnet.
